(19) United States
(12) Patent Application Publication
(10) Pub. No.: US 2002/0028886 A1
(43) Pub. Date: Mar. 7, 2002

(54) Fluorocopolymer and process for preparing the same

(75) Inventors: Katsumi Abe, Chigasaki-shi (JP); Haruyoshi Tatsu, Hitachi-shi (JP)

Correspondence Address: Russell D. Orkin, 700 Koppers Building, 436 Seventh Avenue, Pittsburgh, PA, 15219-1818, US

(73) Assignee: NIPPON MEKTRON, LTD.

(21) Appl. No.: 09/859,550

(22) Filed: May 17, 2001

(30) Foreign Application Priority Data
May 18, 2000 (JP) 2000-146181
Mar. 22, 2001 (JP) 2001-82848

(51) Int. Cl. C08F 114/18

(52) U.S. Cl. 525/326.3; 526/255; 526/242; 526/247; 526/253; 526/249

(57) ABSTRACT

Disclosed is a fluorocopolymer obtained by copolymerizing specific amounts of vinylidene fluoride, a perfluoro(lower alkyl vinyl ether), a specific fluorine compound represented by the following formula (I), a bromine-containing and/or iodine-containing vinyl monomer, and optionally, tetrafluoroethylene

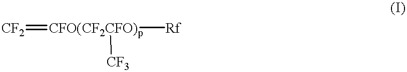

This fluorocopolymer has a glass transition temperature of not higher than −25° C. Also disclosed is a crosslinking composition comprising the fluorocopolymer and a peroxide type crosslinking agent

### FIELD OF THE INVENTION

The present invention relates to a fluorocopolymer (fluoroelastomer), a crosslinking composition containing the fluorocopolymer, and a cured product of the crosslinking composition.

### BACKGROUND OF THE INVENTION

Molding materials for forming oil seals, fuel hoses, etc. of automobiles or air crafts need to have properties of heat resistance, low-temperature resistance, solvent resistance (fuel oil resistance, oil resistance) and the like, and development of resin materials exhibiting these various properties with good balance is expected.

In Japanese Patent Publication No. 1585/1979, a fluoropolymer composition comprising a fluoropolymer obtained by copolymerizing not more than 3% by mol of a bromine-containing olefin and an organic peroxide is described. A peroxide-crosslinked product obtained from this composition, however, lacks solvent resistance although it exhibits low-temperature resistance to a certain degree.

In Japanese Patent Publication No. 4728/1983, a multi-segment fluoropolymer obtained by copolymerization reaction using an iodine compound as a chain transfer agent is described. In this polymer, however, there is a problem that improvement of low-temperature resistance cannot be expected at all because the iodine compound used as a chain transfer agent is a low-molecular weight compound.

Under such circumstances, the present inventors have earnestly studied in order to solve the above problems, and as a result, they have found that a cured product having excellent heat resistance, low-temperature resistance and solvent resistance is obtained by the use of a crosslinking composition containing a specific fluorocopolymer (fluoroelastomer). Based on the finding, the present invention has been accomplished.

### OBJECT OF THE INVENTION

It is an object of the present invention to provide a fluorocopolymer capable of providing a cured product having excellent heat resistance, low-temperature resistance and solvent resistance, a crosslinking composition containing the fluorocopolymer, and a cured product of the composition.

### SUMMARY OF THE INVENTION

The fluorocopolymer according to the invention is a fluorocopolymer comprising:

(a) constituent units derived from vinylidene fluoride, in amounts of 65 to 87% by mol,

(b) constituent units derived from tetrafluoroethylene, in amounts of 0 to 10% by mol,

(c) constituent units derived from a perfluoro(lower alkyl vinyl ether), in amounts of 0 to 25% by mol,

(d) constituent units derived from a fluorine compound represented by the following formula (I), in amounts of 3 to 20% by mol:

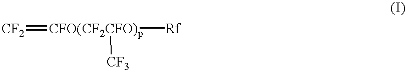

wherein p is an integer of 1 to 3, and Rf is a perfluoroalkyl group of 1 to 3 carbon atoms,

and

(e) constituent units derived from a bromine-containing and/or iodine-containing vinyl monomer, in amounts of 0.1 to 3% by mol,

said fluorocopolymer having a glass transition temperature of not higher than −25° C.

The fluorine compound (D) represented by the formula (I) is preferably a fluorine compound represented by the following formula (II):

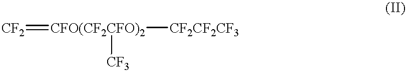

The bromine-containing and/or iodine-containing vinyl monomer is preferably a vinyl monomer (E) represented by the formula CF₂═CHBr or CF₂═CFOCF₂CF₂Br.

The process for preparing a fluorocopolymer according to the invention comprises radical-polymerizing:

(A) vinylidene fluoride in an amount of 65 to 87% by mol,

(B) tetrafluoroethylene in an amount of 0 to 10% by mol,

(C) a perfluoro(lower alkyl vinyl ether) in an amount of 0 to 25% by mol,

(D) a fluorine compound represented by the following formula (I) in an amount of 3 to 20% by mol:

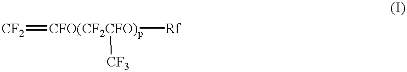

wherein p is an integer of 1 to 3, and Rf is a perfluoroalkyl group of 1 to 3 carbon atoms,

and

(E) a bromine-containing and/or iodine-containing vinyl monomer in an amount of 0.1 to 3% by mol,

in the presence of:

(F) a chain transfer agent represented by the following formula (III):

RIₘBrₙ (III)

wherein R is any one of a fluorohydrocarbon group, a chlorofluorohydrocarbon group, a chlorohydrocarbon group and a hydrocarbon group, each of which may have a functional group X, X is —O—, —S—, ═NR′ (R′ is a hydrogen atom or an alkyl group of 1 to 3 carbon atoms), —COOH, —SO₂, —SO₃H or —PO₃H, m is a natural number, n is an integer of 0 or more, and (n+m) is an integer of 2 or more,

and

(G) an emulsifying agent,

to obtain a fluorocopolymer having a glass transition temperature of not higher than −25° C.

The chain transfer agent (F) represented by the formula RIₘBrₙ is preferably a compound represented by the formula ICF₂CF₂Br.

The emulsifying agent is preferably a perfluoropolyether ammonium carboxylate.

The fluorine-containing crosslinking composition according to the invention comprises the fluorocopolymer and a peroxide type crosslinking agent.

The cured product according to the invention is obtained by curing the fluorine-containing crosslinking composition.

The O-ring according to the invention comprises the cured product, and this O-ring is favorably used as an O-ring for a fuel injector.

### DETAILED DESCRIPTION OF THE INVENTION

### Fluorocopolymer (fluoroelastomer)

The fluorocopolymer according to the invention is a fluorocopolymer comprising:

constituent units (a) derived from vinylidene fluoride (A) (sometimes referred to as “VdF” hereinafter),

optionally constituent units (c) derived from a perfluoro(lower alkyl vinyl ether) (C) (sometimes referred to as “FMVE” hereinafter),

constituent units (d) derived from a fluorine compound (D) (sometimes referred to as “AOVE” hereinafter) represented by the following formula (I):

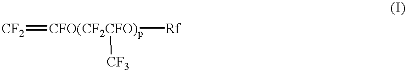

wherein p is an integer of 1 to 3, and Rf is a perfluoroalkyl group of 1 to 3 carbon atoms, constituent units (e) derived from a bromine-containing and/or iodine-containing vinyl monomer (E) (sometimes referred to as “Br/I-CSM” hereinafter),

and optionally

constituent units (b) derived from tetrafluoroethylene (B) (sometimes referred to as “TFE” hereinafter).

The VdF (A) and the TFE (B) can be prepared by known processes, and commercially available ones are also employable.

The perfluoro(lower alkyl vinyl ether) (C), from which the constituent units (c) of the fluorocopolymer of the invention can be derived, is specifically a perfluoro(C₁-C₃ alkyl vinyl ether), and examples thereof include perfluoro(methyl vinyl ether), perfluoro(ethyl vinyl ether) and perfluoro(propyl vinyl ether). Of these, perfluoro(methyl vinyl ether) is preferably employed. The perfluoro(alkyl vinyl ether) can be synthesized by a known process, and a commercially available one is also employable.

Examples of the AOVE (D) represented by the formula (I), from which the constituent units (d) of the fluorocopolymer of the invention can be derived, include the following compounds.

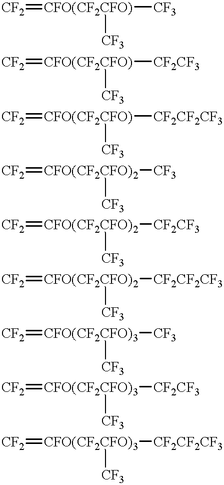

Of these, the following compounds are preferably employed.

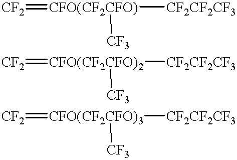

Of these, the following compound is particularly preferably employed from the viewpoints of polymerizability and low-temperature resistance.

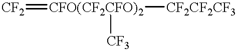

The AOVE (D) can be synthesized by a known process, and a commercially available one is also employable.

Examples of the I/Br-CSM (E), from which the constituent units (e) of the fluorocopolymer of the invention can be derived, include CF₂═CHBr, CF₂═CFCF₂CF₂CF₂Br, CF₂═CHI, CF₂═CFOCF₂CF₂Br, CF₂═CFO(CF₂)₂CF₂Br, CF₂═CFO(CF₂)₃Br, CF₂═CFO(CF₂)₂CFBrCF₃ and CF₂═CFBrOR (R is an alkyl group of 1 to 3 carbon atoms or a fluoroalkyl group of 1 to 3 carbon atoms).

Of these, CF₂═CHBr, CF₂═CHI or CF₂═CFOCF₂CF₂Br is preferably employed in the invention, and CF₂═CHBr or CF₂═CHI is particularly preferably employed in the invention.

The I/Br-CSM (E) can be synthesized by a known process, and a commercially available one is also employable.

The above monomers can be used singly or in combination of two or more kinds.

In the fluorocopolymer of the invention, it is desirable that:

the constituent units (a) derived from the vinylidene fluoride (A) are contained in amounts of preferably 65 to 87% by mol, more preferably 65 to 85% by mol, especially preferably 70 to 80% by mol,

the constituent units (b) derived from the tetrafluoroethylene (B) are contained in amounts of preferably 0 to 10% by mol, more preferably 4 to 8% by mol,

the constituent units (c) derived from the perfluoro(lower alkyl vinyl ether) (C) are contained in amounts of preferably 0 to 25% by mol, more preferably 2 to 25% by mol, especially preferably 5 to 15% by mol,

the constituent units (d) derived from the AOVE (D) are contained in amounts of preferably 3 to 20% by mol, more preferably 4 to 15% by mol, and

the constituent units (e) derived from the I/Br-CSM (E) are contained in amounts of preferably 0.1 to 3% by mol, more preferably 0.2 to 1.5% by mol,

with the proviso that the total amount of the constituent units (a), (b), (c), (d) and (e) is 100% by mol.

When the amounts of the constituent units (a) derived from vinylidene fluoride are smaller than 65% by mol, low-temperature properties of a cured product comprising a crosslinking composition containing the fluoroelastomer are sometimes deteriorated. When the amounts thereof exceed 87% by mol, solvent resistance and chemical resistance of a cured product comprising a crosslinking composition containing the fluoroelastomer are sometimes lowered.

When the amounts of the constituent units (b) derived from tetrafluoroethylene exceed 10% by mol, low-temperature properties of a cured product comprising a crosslinking composition containing the fluoroelastomer are sometimes deteriorated.

When the amounts of the constituent units (d) derived from AOVE are in the above range, a cured product having excellent low-temperature properties and solvent resistance can be obtained.

When the amounts of the constituent units (e) derived from I/Br-CSM are in the above range, not only a vulcanized product having excellent compression set properties but also a vulcanized product having excellent elongation can be obtained.

The fluorocopolymer may further contain a component (f) derived from the later-described compound (F) represented by the following formula (III):

RBrₙIₘ (III)

In this case, the component (f) is desirably contained in an amount of 0.001 to 5 parts by weight, preferably 0.1 to 3 parts by weight, based on 100 parts by weight of the total amount of the constituent units (a), (b), (c), (d) and (e).

Although there is no specific limitation on the molecular weight of the fluorocopolymer (fluoroelastomer), the number-average molecular weight (Mn, measuring method: GPC, solvent: THE) is desired to be in the range of usually 10,000 to 1,000,000, preferably 50,000 to 300,000. The solution viscosity η sp/C (35° C., methyl ethyl ketone) serving as an indication of the molecular weight is desired to be in the range of 0.1 to 5 dl/g, preferably 0.5 to 3.5 dl/g.

The fluorocopolymer has a glass transition temperature of not higher than −25° C., preferably not higher than −30° C.

### Process for Preparing Fluorocopolymer

In order to obtain the fluorocopolymer, there are used vinylidene fluoride (A) from which the constituent units (a) can be derived, in an amount of preferably 65 to 87% by mol, more preferably 65 to 85% by mol, especially preferably 70 to 80% by mol, tetrafluoroethylene (B) from which the constituent units (b) optionally contained can be derived, in an amount of preferably 0 to 10% by mol, more preferably 4 to 8% by mol, perfluoro(lower alkyl vinyl ether) (C) from which the constituent units (c) can be derived, in an amount of preferably 0 to 25% by mol, more preferably 2 to 25% by mol, especially preferably 5 to 15% by mol, AOVE (D) from which the constituent units (d) can be derived, in an amount of preferably 3 to 20% by mel, more preferably 4 to 15% by mol, and I/Br-CSM (E) from which the constituent units (e) can be derived, in an amount of preferably 0.1 to 3% by mol, more preferably 0.2 to 1.5% by mol, and they are subjected to emulsion polymerization or radical polymerization optionally in the presence of a chain transfer agent (F) and an emulsifying agent (G).

### Chain Transfer Agent (F)

As the chain transfer agent (F), an iodine-containing compound or an iodine-containing bromine-containing compound represented by the following formula (III) is employable.

RBrₙIₘ (III)

The chain transfer agent has only not to undergo side reaction under the polymerization conditions and not to lose chain transfer effects. In the formula (III), m is a positive integer, n is 0 or a natural number, n+m≧2, and R is any one of a fluorohydrocarbon group, a chlorofluorohydrocarbon group, a chlorohydrocarbon group and a hydrocarbon group, each of which has 1 to 10 carbon atoms and to each of which a functional group (X), such as —O—, —S—, ═NR′ (R′ is a hydrogen atom or an alkyl group of 1 to 3 carbon atoms), —COOH, —SO₂, —SO₃H or —PO₃H, may be bonded.

As the iodine-containing bromine-containing compound employable as the chain transfer agent (F) represented by the formula (III), an iodine-containing bromine-containing compound, which is a saturated or unsaturated aliphatic or aromatic compound and in which n and m are each 1, is preferably employed. When one of n and m is 2, the resulting fluoroelastomer has a three-dimensional structure, and therefore such a compound is desirably used in an amount not detrimental to the processability

Examples of the chain iodine-containing bromine-containing compounds employable as the chain transfer agent (F) include 1-bromo-2-iodoperfluoroethane, 1-bromo-3-iodoperfluoropropane, 1-bromo-4-iodoperfluorobutane, 2-bromo-3-iodoperfluorobutane, 1-brono-2-iodoperfluoro(2-methylpropane), monobromo-momonoiodoperfluorocyclobutane, monobromo-momonoiodoperfluoropentane, monobromo-momonoiodoperfluoro-n-octane, monobromo-momonoiodoperfluorocyclohexane, 1-bromo-l-iodo-2-chloroperfluoroethane, 1-bromo-2-iodo-2-chloroperfluoroethane, 1-iodo-2-bromo-2-chloroperfluoroethane, 1,1-dibromo-2-iodoperfluoroethane, 1,2-dibromo-2-iodoperfluoroethane, 1,2-diiodo-2-bromoperfluoroethane, 1-bromo-2-iodo-1,2,2-trifluoroethane, 1-iodo-2-bromo-1,2,2-trifluoroethane, 1-bromo-2-iodo-1,1-difluoroethane, 1-iodo-2-bromo-1,1-difluoroethane, 1-bromo-2-iodo-1-fluoroethane, 1-iodo-2-bromo-1-fluoroethane, 1-bromo-2-iodo-1,1,3,3,3-pentafluoropropane, 1-iodo-2-bromo-1,1,3,3,3-pentafluoropropane, 1-bromo-2-iodo-3,3,4,4,4-pentafluorobutane, 1-iodo-2-bromo-3,3,4,4,4-pentafluorobutane, 1,4-dibromo-2-iodoperfluorobutane, 2,4-dibromo-1-iodoperfluorobutane, 1,4-diiodoperfluorobutane, 1,4-diiodo-2-bromoperfluoroethane, 1,4-dibromo-2-iodo-3,3,4,4-tetrafluorobutane, 1,4-diiodo-2-bromo-3,3,4,4-tetrafluorobutane, 1,1-dibromo-2,4-diiodoperfluorobutane, 1-bromo-2-iodo-1-chloroethane, 1-iodo-2-bromo-1-chloroethane, 1-bromo-2-iodo-2-chloroethane, 1-bromo-2-iodo-1,1-dichloroethane, 1,3-dibromo-2-iodoperfluoropropane, 2,3-dibromo-2-iodoperfluoropropane, 1,3-diiodo-2-bromoperfluoropropane, 1-bromo-2-iodoethane, 1-bromo-2-iodopropane, 1-iodo-2-bromopropane, 1-bromo-2-iodobutane, 1-iodo-2-bromobutane, 1-bromo-2-iodo-2-trifluoromethyl-3,3,3-trifluoropropane, 1-iodo-2-bromo-2-trifluoromethyl -3,3,3-trifluoropropane, 1-bromo-2-iodo-2-phenylperfluoroethane, 1-iodo-2-bromo-2-phenylperfluoroethane, 3-bromo-4-iodoperfluorobutene-1, 3-iodo-4-bromoperfluorobutene-1, 1-bromo-4-iodoperfluorobutene-1, 1-iodo-4-bromoperfluorobutene-1, 3-bromo-4-iodo-3,4,4-trifluorobutene-1, 4-bromo-3-iodo-3,4,4-trifluorobutene-1, 3-bromo-4-iodo-1,1,2-trifluorobutene-1, 4-bromo-5-iodoperfluoropentene-1, 4-iodo-5-bromoperfluoropentene-1, 4-bromo-5-iodo-1,1,2-trifluoropentene-1, 4-iodo-5-bromo-1,1,2-trifluoropentene-1, 1-bromo-2-iodoperfluoroethyl perfluoromethyl ether, 1-bromo-2-iodoperfluoroethyl perfluoromethyl ether, 1-bromo-2-iodoperfluoroethyl perfluoropropyl ether, 2-bromo-3-iodoperfluoropropyl perfluorovinyl ether, 1-bromo-2-iodoperfluoroethyl perfluorovinyl ether, 1-bromo-2-iodoperfluoroethyl perfluoroallyl ether, 1-bromo-2-iodoperfluoroethyl methyl ether, 1-iodo-2-bromoperfluoroethyl ethyl ether, 1-iodo-2-bromoethyl ethyl ether and 1-bromo-2-iodoethyl-2′-chloroethyl ether. These iodine-containing bromine-containing compounds can be prepared by appropriate known processes. For example, a fluoroolefin is allowed to react with iodine bromide to obtain a monobromo-monoiodofluoroolefin.

Examples of the aromatic iodine-containing bromine-containing compounds employable as the chain transfer agent (F) include substitution products of benzene, such as 1-iodo-2-bromobenzene, 1-iodo-3-bromobenzene, 1-iodo-4-bromobenzene, 3,5-dibromo-1-iodobenzene, 3,5-diiodo-l-bromobenzene, 1-(2-iodoethyl)-4-(2-bromoethyl)benzene, 1-(2-iodoethyl)-3-(2-bromoethyl)benzene, 1-(2-iodoethyl)-4-(2-bromoethyl)benzene, 3,5-bis(2-bromoethyl)-1-(2-iodoethyl)benzene, 3,5-bis(2-iodoethyl) -1-(2-bromoethyl)benzene, 1-(3-iodopropyl)-2-(3-bromopropyl)benzene, 1-(3-iodopropyl)-3-(3-bromopropyl)benzene, 1-(3-iodopropyl)-4-(3-bromopropyl)benzene, 3,5-bis(3-bromopropyl)-1-(3-iodopropyl)benzene, 1-(4-iodobutyl)-3-(4-bromobutyl)benzene, 1-(4-iodobutyl)-4-(4-bromobutyl)benzene, 3,5-bis(4-iodobutyl)-l-(4-bromobutyl)benzene, 1-(2-iodoethyl)-3-(3-bromopropyl)benzene, 1-(3-iodopropyl)-3-(4-bromobutyl)benzene, 3,5-bis(3-bromopropyl)-1-(2-iodoethyl)benzene, 1-iodo-3-(2-bromoethyl)benzene, 1-iodo-3-(3-bromopropyl)benzene, 1,3-diiodo-5-(2-bromoethyl)benzene, 1,3-diiodo-5-(3-bromopropyl)benzene, 1-bromo-3-(2-iodoethyl)benzene, 1-bromo-3-(3-iodopropyl)benzene, 1,3-dibromo-5-(2-iodoethyl)benzene and 1,3-dibromo-5-(3-iodopropyl)benzene; and substitution products of perfluorobenzene, such as 1-iodo-2-bromoperfluorobenzene, 1-iodo-3-bromoperfluorobenzene, 1-iodo-4-bromoperfluorobenzene, 3,5-dibromo-1-iodoperfluorobenzene and 3,5-diiodo-1-bromoperfluorobenzene.

Examples of the iodine-containing compounds employable as the chain transfer agent (F) include 1,2-diiodotetrafluoroethane, 1,3-diiodohexafluoropropane, 1,4-diiodooctafluorobutane, iodoperfluoroethylene, iodo-1,1-difluoroethylene, odoethylene, 2-iodoperfluoroethyl vinyl ether, 1, 7-diiodoperfluoro-n-octane, 1,12-diiodoperfluorododecane, 1,16-diiodoperfluorohexadecane, 1,3-diiodo-2-chloroperfluoro-n-propane and 1,5-diiodo-2,4-dichloroperfluoro-n-pentane.

Of the chain transfer agents mentioned above, 1-bromo-2-iodoperfluoroethane, 1,4-diiodoperfluorobutane or 1-bromo-4-iodoperfluorobutane is preferably employed, and 1-bromo-2-iodoperfluoroethane is particularly preferably employed.

The bromine-containing compound, the iodine-containing bromine-containing compound or the iodine-containing compound acts on the copolymer as a chain transfer agent for forming a crosslinkage site, to modify a molecular weight of the copolymer. Therefore, the processability of the crosslinking composition can be improved.

As for the above compounds, e.g., the iodine-containing bromine-containing compound, it is presumed that by virtue of occurrence of an organic peroxide radical in the polymerization reaction, radical cleavage of iodine or bromine of the iodine-containing bromine-containing compound easily takes place to form a radical of high reactivity, whereby the monomer undergoes addition growth reaction, then iodine and bromine are abstracted from the iodine-containing bromine-containing compound to terminate the reaction, and as a result, a fluoroelastomer having iodine and bromine bonded at the molecular ends is formed. The iodine atom and the bromine atom bonded at the molecular ends have a function of a crosslinkage site when the peroxide vulcanization is carried out.

The chain transfer agent (F) is desirably contained in an amount of 0.001 to 5 parts by weight, preferably 0.1 to 3 parts by weight, based on 100 parts by weight of the total of the vinylidene fluoride (A), the tetrafluoroethylene (B) that is optionally used, the perfluoro(lower alkyl vinyl ether) (C), the AOVE (D) and the I/Br-CSM (E).

### Emulsion Polymerization

The copolymerization reaction in the invention can be conducted by an emulsion polymerization process using an emulsifying agent and a water-soluble peroxide catalyst, preferably its redox catalyst, generally in an aqueous medium, or can also be conducted by a radical solution polymerization process using a fluorine type solvent.

The polymerization reaction by the emulsion polymerization process is described below.

The emulsifying agent preferably used for the emulsion polymerization is, for example, a perfluoropolyether ammonium carboxylate represented by the following formula (IV):

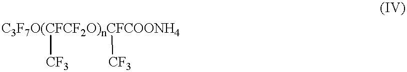

wherein n is an integer of 1 to 3.

The emulsifying agent is desirably used in an amount of 0.001 to 25% by weight, preferably 0.01 to 20% by weight, based on the amount of the aqueous medium.

Examples of the water-soluble peroxide catalysts preferably used for the emulsion polymerization include persulfates, such as ammonium persulfate, potassium persulfate and sodium persulfate.

When a fluorinated alcohol that is soluble in both of water and the monomer component is added to the aqueous phase of the polymerization mixture in the fluorocopolymerization reaction, the solubility of the monomer in the aqueous phase is increased to contribute to the transfer of the monomer from the droplet suspended in the aqueous medium to the polymerization site. Examples of the fluorinated alcohols include trifluoroethanol, hexafluoroisopropanol and ω-hydro-2,2,3,3-tetrafluoropropanol. When the fluorinated alcohol is used, the amount thereof is desired to be in the range of 0.2 to 5% by weight, preferably 1 to 3% by weight, based on the amount of the aqueous medium.

The emulsion polymerization using the emulsifying agent and the water-soluble peroxide catalyst is desirably carried out at a temperature of about 0 to 80° C., preferably about 20 to 60° C. When the reaction temperature exceeds 80° C., the molecular weight of the resulting copolymer is sometimes lowered, and the decomposition rate of the polymerization catalyst becomes too high to occasionally induce lowering of efficiency. When the reaction temperature is lower than 0° C., the polymerization rate is sometimes lowered and is not for practical use. The polymerization pressure is desired to be as high as possible with the proviso that a copolymer of homogeneous composition can be obtained, but in general, a pressure of not higher than about 100 kg/cm²-G is employed.

In the preparation of the fluorocopolymer according to the invention, a chain transfer agent such as methanol, ethanol, isopentane, diethyl malonate or carbon tetrachloride may be used in the polymerization to modify the molecular weight of the resulting fluorocopolymer.

### Crosslinking Composition, Cured Product and Uses Thereof

The crosslinking composition according to the invention comprises the fluorocopolymer and a peroxide type crosslinking agent.

The crosslinking composition containing the fluorocopolymer according to the invention can be cured by hitherto known various vulcanization methods, such as peroxide vulcanization using an organic peroxide, polyamine vulcanization using a polyamine compound and polyol vulcanization using a polyhydroxy compound, or irradiation methods, such as irradiation with radiation or electron rays. Of these methods, the peroxide vulcanization is particularly preferably used, because the cured product of the crosslinking composition has excellent mechanical strength, and besides a carbon-carbon bond having stable crosslinkage point structure is formed, so that the cured product of the crosslinking composition exhibits excellent chemical resistance, abrasion resistance and solvent resistance.

Examples of the organic peroxides used for the peroxide vulcanization include 2,5-dimethyl-2,5-bis(tert-butylperoxy)hexane, 2,5-dimethyl-2,5-bis(tert-butylperoxy)hexyne-3, benzoyl peroxide, bis(2,4-dichlorobenzoyl)peroxide, dicumyl peroxide, di-tert-butyl peroxide, tert-outylcumyl peroxide, tert-butyl peroxybenzene, 1,1-bis(tert-butylperoxy)-3,5,5-trimethylcyclohexane, 2,5-dimethylhexane-2,5-dihydroxyperoxide, α,α′-bis(tert-butylperoxy)-p-diisopropylbenzene, 2,5-dimethyl-2,5-di(benzoylperoxy)hexane and tert-butylperoxy isopropylcarbonate.

In the peroxide vulcanization using the above organic peroxides, a polyfunctional unsaturated compound, such as tri(meth)allyl isocyanurate, tri(meth)allyl cyanurate, triallyl trimellitate, N,N′-m-phenylenebismaleimide, diallyl phthalate, tris(diallylamine)-s-triazine, triallyl phosphite, 1,2-polybutadiene, ethylene glycol diacrylate or diethylene glycol diacrylate, can be used as a co-crosslinking agent in combination. By the use of the co-crosslinking agent in combination, a crosslinking composition having better vulcanization properties, mechanical strength and compression set properties can be obtained.

Further, an oxide or hydroxide of a divalent metal, such as an oxide or hydroxide of calcium, magnesium, lead or zinc, can be used as a crosslinking assistant, if desired. Such a compound also functions as an acid-receiving agent.

To the peroxide vulcanization system, each component is added in the following amount based on 100 parts by weight of the fluorocopolymer. The organic peroxide is used in an amount of 0.1 to 10 parts by weight, preferably about 0.5 to 5 parts by weight. When the co-crosslinking agent is used if desired, the amount thereof is in the range of 0.1 to 10 parts by weight, preferably about 0.5 to 5 parts by weight. When the crosslinking assistant is used if desired, the amount thereof is not more than 15 parts by weight, preferably 2 to 10 parts by weight.

The crosslinking composition of the invention can be prepared by adding the above components as they are to the fluorocopolymer and then kneading the mixture. The mixture may be diluted with carbon black, silica, clay, talc, diatomaceous earth, barium sulfate or the like, or a masterbatch dispersion containing the fluorocopolymer may be prepared. To the composition, hitherto known additives, such as filler, reinforcing agent, plasticizer, lubricant, processing aid and pigment, can be properly added in addition to the above components. When carbon black is used as a filler or a reinforcing agent, the amount thereof is preferably in the range of about 10 to 50 parts by weight based on 100 parts by weight of the fluorocopolymer.

Vulcanization of the crosslinking composition can be carried out by mixing the components through a mixing method generally used, such as roll mixing, kneader mixing, Banbury mixing or solution mixing, and then heating the mixture. The heating is preferably carried out by first conducting press vulcanization at a temperature of about 100 to 250° C. for about 1 to 120 minutes and then conducting oven vulcanization (secondary vulcanization) at a temperature of about 150 to 300° C. for 0 to 30 hours.

The cured products of the crosslinking composition can be used as oil seals, fuel hoses, etc. of automobiles and air crafts. The cured products according to the invention are particularly excellent in heat resistance, low-temperature resistance and solvent resistance, and therefore they can be favorably used as various O-rings, particularly O-rings used for fuel injectors of automobiles or air crafts.

### Effect of the Invention

From the crosslinking composition comprising the fluorocopolymer of the invention, a cured product having excellent heat resistance, low-temperature resistance and solvent resistance can be obtained.

### EXAMPLE

The present invention is further described with reference to the following examples, but it should be construed that the invention is in no way limited to those examples.

### Example 1

In a 500 ml autoclave, the following components were placed.

| | | |
|---|---|---|
| Vinylidene fluoride (VdF) | 44 | g (76.5 mol %) |
| Tetrafluoroethylene (TFE) | 6 | g (6.6 mol %) |
| Perfluoro(methyl vinyl ether) | (FMVE) | |
| | 16 | g (10.6 mol %) |
| CF₂═CF₂O(CF₂C(CF₃)FO)₂CF₂CF₂CF₃ | (AOVE) | |
| | 32 | g (6.0 mol %) |
| CF₂═CFOCF₂CF₂Br (Br-CSM) | 1 | g (0.3 mol %) |
| ICF₂CF₂Br | 0.1 | g |
| C₃F₇OC(CF₃)FCF₂OC(CF₃)FCOONH₄ | 20 | g |
| Hexafluoroisopropanol | 5 | g |
| Na₂HPO₄.12H₂O | 0.4 | g |
| NaHSO₃ | 0.02 | g |
| Water | 200 | ml |

Then, the temperature of the system was raised to 50° C., and 0.1 g of ammonium persulfate was added to initiate polymerization reaction. The reaction was conducted at 50° C. for 5 hours, then the system was cooled, and the unreacted gas was released to terminate the polymerization reaction.

The resulting latex was subjected to salting-out using a 2% calcium chloride aqueous solution and then dried to obtain 86.8 g (polymerization ratio: 87.7%) of a white fluorocopolymer.

From the ¹⁹F-NMR analysis, it was confirmed that the fluorocopolymer contained constituent units of VdF/TFE/FMVE/AOVE/Br-CSM in a ratio of 80.4/5.2/9.6/4.5/0.3.

### Example 2, Comparative Examples 1 and 2

A fluorocopolymer was prepared in the same manner as in Example 1, except that VdF, TFE, FMVE, AOVE and Br-CSM were used in the amounts shown in Table 1. The composition ratio of the resulting fluorocopolymer is set forth in Table 1.

TABLE 1

| | | | Comp. | Comp. |
|---|---|---|---|---|
| | Ex. 1 | Ex. 2 | Ex. 1 | Ex. 2 |
| Weight of monomer | | | | |
| charged | | | | |
| VdF (g) | 44 | 54 | 41 | 44 |
| TFE (g) | 6 | 6 | 9 | — |
| FMVE (g) | 16 | — | 30 | 12 |
| AOVE (g) | 32 | 60 | — | — |
| I/Br-CSM (g) | 1 | 1 | 1 | 1 |
| Ratio of monomer | | | | |
| charged | | | | |
| VdF (mol %) | 76.5 | 83.7 | 69.7 | 77.7 |
| TFE (mol %) | 6.6 | 6.0 | 10.0 | — |
| FMVE (mol %) | 10.6 | — | 20.0 | 22.0 |
| AOVE (mol %) | 6.0 | 10.0 | — | — |
| I/Br-CSM (mol %) | 0.3 | 0.3 | 0.3 | 0.3 |
| Composition ratio | | | | |
| of fluorocopolymer | | | | |
| VdF (mol %) | 80.4 | 85.3 | 72.0 | 82.0 |
| TFE (mol %) | 5.2 | 4.4 | 10.0 | — |
| FMVE (mol %) | 9.6 | — | 17.7 | 17.7 |
| AOVE (mol %) | 4.5 | 10.0 | — | — |
| I/Br-CSM (mol %) | 0.3 | 0.3 | 0.3 | 0.3 |

### Example 3

To 100 parts by weight of the fluorocopolymer obtained in Example 1, the following components were added, and they were kneaded by a two-roll mill to give a mixture.

Organic peroxide (Perhexa 2.5B-40, available from

| | |
|---|---|
| Organic peroxide (Perhexa 2.5B-40, available from | 1.4 parts by weight |
| Nippon Oils & Fats Co., Ltd.) | |
| Triallyl isocyanurate (60%) | 7 parts by weight |
| Zinc oxide (ZnO) | 6 parts by weight |
| MT carbon black | 30 parts by weight |

The mixture was subjected to press vulcanization at 180° C. for 10 minutes and then subjected to oven vulcanization (secondary vulcanization) at 230° C. for 22 hours. The resulting vulcanized sheet was measured on the ordinary state properties (in accordance with DIN 53505 and 53504), heat resistance (heat aging resistance test, 230° C., 70 hours), low-temperature resistance (TR test) and solvent resistance (change of volume after immersion in methanol at 25° C. for 70 hours). The results are set forth in Table 2.

### Example 4, Comparative Examples 3 and 4

Separately, to each of the fluorocopolymers obtained in Example 2 and Comparative Examples 1 and 2, an organic peroxide, triallyl isocyanurate, zinc oxide and MT carbon black were added in the same manner as in the above Example 3. Then, each of the resulting mixtures was vulcanized in the same manner as in the above Example 3. The resulting vulcanized sheets were measured on the ordinary state properties, heat resistance, low-temperature resistance and solvent resistance. The results are set forth in Table 2 as those of Example 4, Comparative Example 3 and Comparative Example 4.

TABLE 2

| | | | Comp. | Comp. |
|---|---|---|---|---|
| | Ex. 3 | Ex. 4 | Ex. 3 | Ex. 4 |
| Ordinary state | | | | |
| properties | | | | |
| Hardness | 83 | 95 | 75 | 70 |
| (Shore A) (pts) | | | | |
| Tensile strength | 13.2 | 11.2 | 19.4 | 18.0 |
| (Mps) | | | | |
| Elongation (%) | 230 | 170 | 270 | 310 |
| Heat aging | | | | |
| resistance test | | | | |
| A_{H} (pts) | −3 | 0 | 0 | 0 |
| A_{C} (%, T_{B}) | −3 | −5 | −9 | −8 |
| A_{C} (%, E_{B}) | −9 | −3 | +7 | +3 |
| Low-temperature | | | | |
| resistance | | | | |
| TR₁₀ (° C.) | −33.3 | −35.0 | −30.9 | −32.4 |
| Solvent resistance | | | | |
| Methanol (%) | +31.3 | 5.7 | +99.4 | +153.5 |

What is claimed is:

1. A fluorocopolymer comprising:
(a) constituent units derived from vinylidene fluoride, in amounts of 65 to 87% by mol,
(b) constituent units derived from tetrafluoroethylene, in amounts of 0 to 10% by mol,
(c) constituent units derived from a perfluoro(lower alkyl vinyl ether), in amounts of 0 to 25% by mol,
(d) constituent units derived from a fluorine compound represented by the following formula (I), in amounts of 3 to 20% by mol: 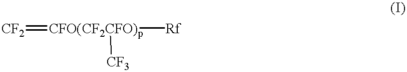
wherein p is an integer of 1 to 3, and Rf is a perfluoroalkyl group of 1 to 3 carbon atoms, and
(e) constituent units derived from a bromine-containing and/or iodine-containing vinyl monomer, in amounts of 0.1 to 3% by mol,
said fluorocopolymer having a glass transition temperature of not higher than −25° C.

2. The fluorocopolymer as claimed in claim 1, wherein the fluorine compound (D) represented by the formula (I) is a fluorine compound represented by the following formula (II):

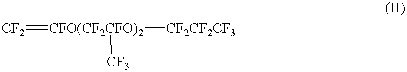

3. The fluorocopolymer as claimed in claim 1 or 2, wherein the bromine-containing and/or iodine-containing vinyl monomer is a vinyl monomer (E) represented by the formula CF₂═CHBr or CF₂═CFOCF₂CF₂Br.

4. A process for preparing a fluorocopolymer, comprising radical-polymerizing:
(A) vinylidene fluoride in an amount of 65 to 87% by mol,
(B) tetrafluoroethylene in an amount of 0 to 10% by mol,
(C) a perfluoro(lower alkyl vinyl ether) in an amount of 0 to 25% by mol,
(D) a fluorine compound represented by the following formula (I) in an amount of 3 to 20% by mol: 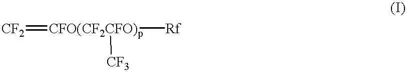
wherein p is an integer of 1 to 3, and Rf is a perfluoroalkyl group of 1 to 3 carbon atoms, and
(E) a bromine-containing and/or iodine-containing vinyl monomer in an amount of 0.1 to 3% by mol, in the presence of:
(F) a chain transfer agent represented by the following formula (III):
RIₘBrₙ (III)
wherein R is any one of a fluorohydrocarbon group, a chlorofluorohydrocarbon group, a chlorohydrocarbon group and a hydrocarbon group, each of which may have a functional group X, X is —O—, —S—, ═NR′ (R′ is a hydrogen atom or an alkyl group of 1 to 3 carbon atoms), —COOH, —SO₂, —SO₃H or —PO₃H, m is a natural number, n is an integer of 0 or more, and (n+m) is an integer of 2 or more, and
(G) an emulsifying agent, to obtain a fluorocopolymer having a glass transition temperature of not higher than −25° C.

5. The process for preparing a fluorocopolymer as claimed in claim 4, wherein the chain transfer agent (F) represented by the formula RIₘBrₙ is a compound represented by the formula ICF₂CF₂Br.

6. The process for preparing a fluorocopolymer as claimed in claim 4 or 5, wherein the emulsifying agent is a perfluoropolyether ammonium carboxylate.

7. A fluorine-containing crosslinking composition comprising the fluorocopolymer of any one of claims 1 to 3 and a peroxide type crosslinking agent.

8. A cured product obtained by curing the fluorine-containing crosslinking composition of claim 7.

9. An O-ring comprising the cured product of claim 8.

10. An O-ring for a fuel injector, comprising the cured product of claim 8.
